(19) United States
(12) Patent Application Publication
(10) Pub. No.: US 2019/0059391 A1
(43) Pub. Date: Feb. 28, 2019

(54) Shark Repellant

(71) Applicant: Shree Kurup, Tucson, AZ (US)

(72) Inventor: Shree K. Kurup, Tucson, AZ (US)

(21) Appl. No.: 16/041,753

(22) Filed: Jul. 21, 2018

Related U.S. Application Data
(60) Provisional application No. 62/548,948, filed on Aug. 22, 2017.

(51) Int. Cl. A01N 65/00; A01N 25/02; A01N 25/34

(52) U.S. Cl. CPC A01N 65/00; B63C 2009/0088; A01N 25/34; A01N 25/02

(57) ABSTRACT

A water soluble organic mixture introduced in water as a deterrent to sharks. This model has been tested and has proven to be effective at deterring sharks from foods tested (other fishes and chicken). This organic deterrent comprises a mixture of iodinated water with garcinia gumma gutta and spices.

### CROSS REFERENCE TO PRIOR COPENDING APPLICATIONS

This application claims benefit or prior co-pending Provisional Patent Application 62/548,948 filed Aug. 27, 2017.

### BACKGROUND

Shark attacks have always been a problem for people who work or relax in maritime environment. The pattern of shark attacks typically involves more than one bite and the second or third bites make it fatal¹. Any measure to prevent the shark from re attacking conceivably would save life or limb. Sharks also poach fishing nets causing a huge loss to fishing. If a device that slow releases a non toxic compound that repels sharks as a liquid barrier would be useful commercially.

### SUMMARY OF INVENTION

The invention proposed a water soluble proprietary mixture that has been tested in controlled conditions to dissuade small sharks from feeding on meat pieces. This model has undergone rigorous testing and has proven to be effective at deterring sharks from foods tested (other fishes and chicken).

### BRIEF DESCRIPTION OF THE FIGURES

FIG. 1 is a screen shot taken from a video showing a shark in a dormant pose before injection of the organic deterrent employed according to this invention.

FIG. 2 is another screen shot taken from the same video as FIG. 1 and showing initial injection of the organic deterrent according to this invention being initially introduced into the water while the shark is still in a dormant pose.

FIG. 3 is another screen shot taken from the same video as FIGS. 1 and 2 after the shark has become agitated by introduction of the organic deterrent close to the shark's head.

FIG. 4 is another screen shot taken from the same video as FIGS. 1-3 showing the continuation of the agitated condition of the shark after the state shown in FIG. 3.

### DETAILS OF INVENTION

This invention consists of a mix of iodinated water with garcinia gumma gutta and other spices. The concentration will vary from 10% to 2%. The product will be available as free flowing liquid as well as contained in relatively thin spherules or small spheres or spherical bodies and relatively thin wall tubules or small tubes, each made of commonly used material for medication capsules and that are compressible and prone to easy rupture. This can be incorporated in swimmers clothing as well as attached to fishing nets. Furthermore, this product is biodegradable, natural and safe for consumption by a human if swallowed accidently.

The tubules could be wrapped in any form since it flexible and be filled with the solution. The spherules could be stuck, connected to each other and hung or kept free floating to form chains to create a semi protected beach. The formulation is composed of daily used products and is non toxic for skin and mucous membranes and eyes.

### REFERENCES

Pathologic features of fatal shark attacks Byard R W, Gilbert J D, Brown K. Am J Forensic Med Pathol. 2000 Sep; 21(3):225-9. PMID:10990281

Qualitative tests have been conducted to test the effectiveness of an organic deterrent to sharks by demonstrating the effectiveness of the deterrent on juvenile sharks or Sphyrna Tiburo sharks.

Sphyrna Tiburo sharks, otherwise know as bonnethead sharks were kept alive in a large research pool or holding tank. Sharks were caught in the holding tank with a dripnet and put into tonic immobility. Small concentrations of the organic deterrent were injected into the tank directly above the shark's nares or into their mouths. The response was characterized with respect to controlled trials, in which saltwater is injected in the same fashion. The concentration can be varied and behavioral responses are directly related to the concentration of the deterrent. All trials are recorded with video.

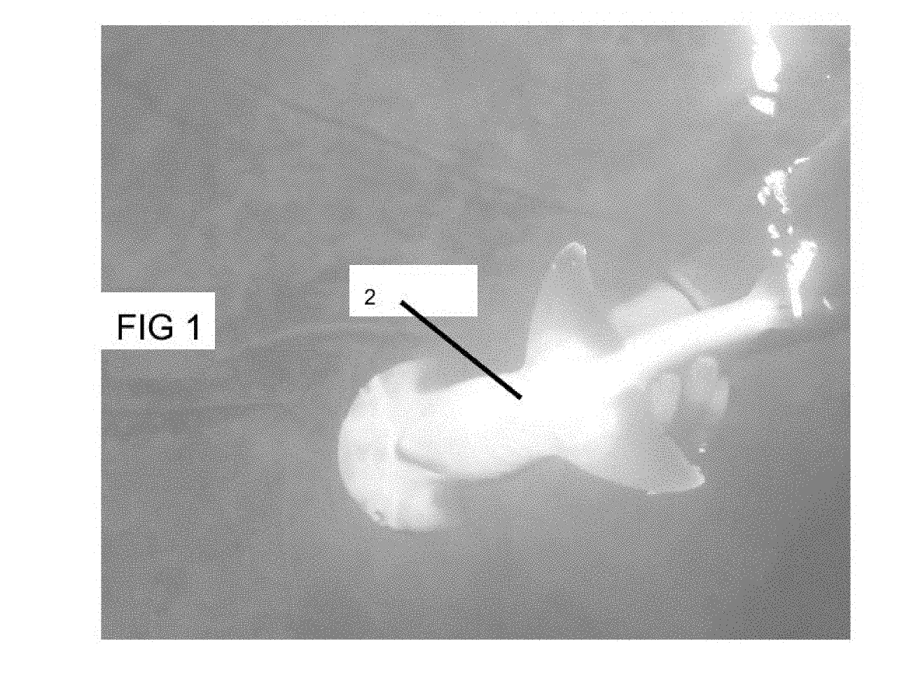

FIGS. 1-4 show the results of preliminary trials conducted in this manner. As shown in FIG. 1, a shark 2 can be held in a dormant pose during which even surgery can be performed on the shark.

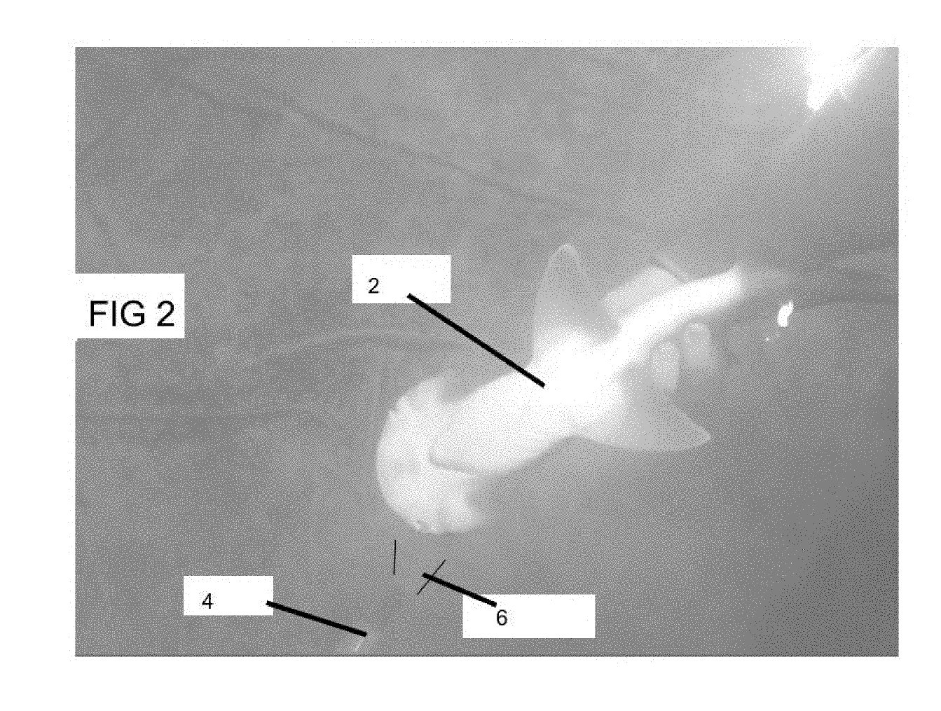

As shown in FIG. 2 a syringe 2 containing the organic deterrent can be positioned adjacent to the shark's head while still in the dormant pose, and a the organic deterrent can be ejected from the syringe 2 forming a column 6. FIG. 2 shows the initial injection of the organic deterrent, and the initial amount of deterrent injected has been relatively small so that the shark 2 remains in a dominant pose. In a video, from which FIG. 2 has been taken, the deterrent appears as a brown liquid injected into the water.

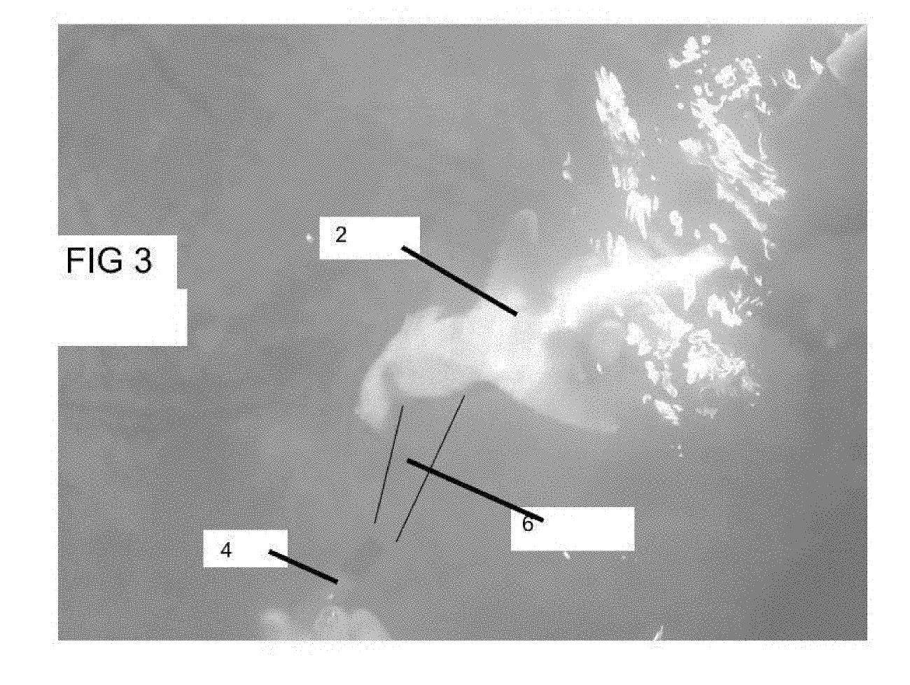

FIG. 3 shows the reaction of the shark 2 when a sufficient amount of the organic deterrent has been injected. The shark 2 has become agitated when a sufficient amount of deterrent has been injected in the vicinity of the head of the shark 2. This agitated state shows how the shark hates the organic deterrent according to this invention.

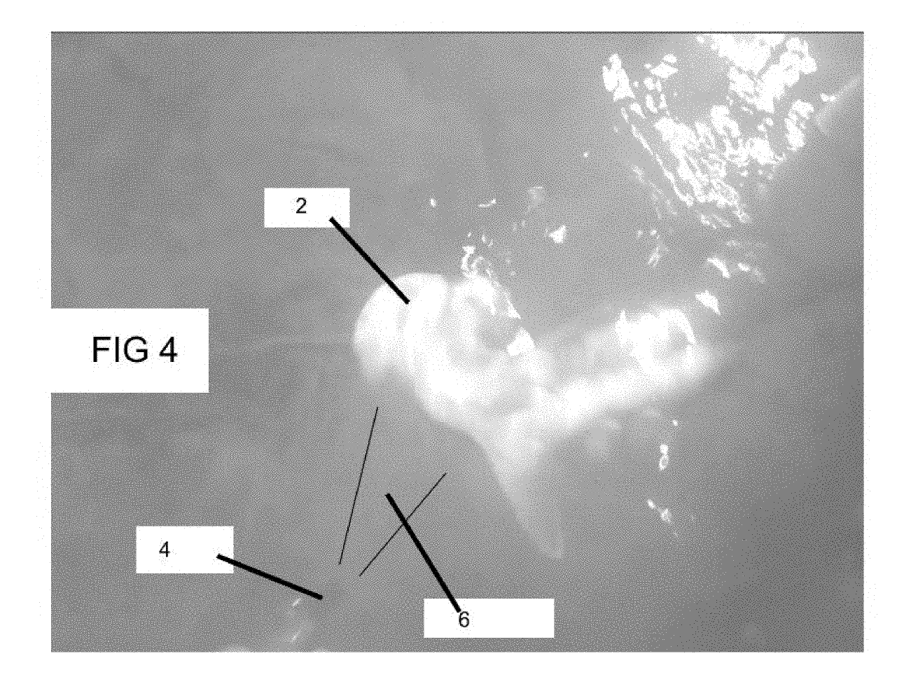

FIG. 4 is similar to FIG. 3 and shows that the relatively violent agitation shown in FIG. 3 has continued. Indicating that the reaction of the shark 2 to the organic deterrent was not isolated, as is apparent from the video from which FIGS. 3 and 4 were generated.

Tests conducted to date show a stronger reaction when the deterrent is introduced into or adjacent the shark's mouth than when injected into or adjacent the shark's snares.

I claim:

1. A shark deterrent comprising a water soluble mixture of iodinated water with garcinia gumma gutta.

2. The shark deterrent of claim 1 wherein the mixture includes additional spices.

3. The shark deterrent of claim 2 wherein the concentration of garcinia gumma gutta and spices is between 2% and 10% by volume.

4. The shark deterrent of claim 2 wherein the concentration of garcinia gumma gutta and spices is between 2% and 10% by weight.

5. The shark deterrent of claim 1 wherein the mixture is a liquid.

6. The shark deterrent of claim 1 wherein the mixture contained in spherules, small spheres or bodies.

7. The shark deterrent of claim 6 wherein the spherules, small spheres or bodies are compressible and prone to rupture.

8. The shark deterrent of claim 7 wherein the spherules, small spheres or bodies are connected to each other to from free floating chains to create a semi protected beach

9. The shark deterrent of claim 1 wherein the mixture is contained in thin wall tubules or small tubes.

10. The shark deterrent of claim 9 wherein the thin wall tubules or small tubes are compressible and prone to rupture.

11. The shark deterrent of claim 9 wherein the thin wall tubules or small tubes are connected to each other to from free floating chains to create a semi protected beach

12. The shark deterrent of claim 1 wherein the mixture is deposited on clothing for swimmers.

13. The shark deterrent of claim 1 wherein the mixture is deposited on fishing nets.

14. The shark deterrent of claim 1 wherein the mixture is biodegradable.

15. The shark deterrent of claim 1 wherein the mixture is safe for human consumption.

16. A method of deterring a shark comprising the step of introducing a water soluble mixture of iodinated water with garcinia gumma gutta in the vicinity of the shark's head.

17. The method of claim 16 wherein the mixture is introduced in the vicinity of the shark's mouth.

18. The method of claim 16 wherein the mixture includes additional spices.

19. The method of claim 16 wherein the mixture is introduced as a liquid from a syringe.

20. The method of claim 16 wherein the mixture is introduced in capsules having walls subject to ruptures when damaged by a shark.
